(19) United States
(12) Patent Application Publication
(10) Pub. No.: US 2005/0037044 A1
(43) Pub. Date: Feb. 17, 2005

(54) Composition for treatment of biting and penetrating organisms and parasites, and urticaria and method of use

(76) Inventor: William M. Yarbrough, Peoria, IL (US)

Correspondence Address: King & Jovanovic, PLC, 170 College Avenue, SUITE 230, HOLLAND, MI, 49423, US

(21) Appl. No.: 10/638,441

(22) Filed: Aug. 12, 2003

(51) Int. Cl. A01N 25/00; A01N 43/42

(52) U.S. Cl. 424/405

(57) ABSTRACT

A treatment for biting and penetrating organisms and parasites is provided for in a topical treatment. According to the invention, a method is provided for applying composition substances to the affected area, working the composition into the affected area, and removing the composition from the affected area. The composition comprises at least one ethoxylate, a sarcosinate, and a scrubbing agent. Alternatively, the ethoxylate can be exchanged for a methoxylate or a propoxylate. Acetylated lanolin alcohol, sodium lauroyl sarcosinate, EDTA, a foam stabilizer, and water can also be added to the composition to assist performance.

### FIELD OF THE INVENTION

The present invention relates to a composition including a sarcosinate, an ethoxylate, and a scrubbing agent and a method for using the same in the treatment of biting and penetrating organisms and parasites, including but not limited to sea lice, swimmer's itch, fire coral, chiggers, and the like, and urticaria.

### BACKGROUND OF THE INVENTION AND PRIOR ART

Many biting and parasitic organisms are capable of infecting humans and causing pruritic, urticarial-like reactions. Common among these parasites are sea lice or thimble jellyfish larva (“sea bather's eruption”), shistosomes (“swimmer's itch”), coelenterate (“fire coral”), and chiggers.

For example, Sea lice are actually small parasites that affect fish. Current research suggests a larval (microscopic) form of the thimble jellyfish is responsible for the reaction. Jellyfish belong to a group of sea animals called Cnidarians. Cnidarians include corals, hydroids, jellyfish and Portuguese man-of-war. The thimble jelly fish (Linuche Unguiculata) larvae are so small that they are barely visible.

The larvae are trapped in the bathing suits of swimmers. Once trapped, the jelly fish stings the swimmer causing the reaction known as seabather's eruption. The dermatitis usually becomes noticeable between four and 24 hours after exposure, although some persons do complain of a “prickling” sensation while still in the water. Lesions from seabather's eruption range from a barely discernible macular rash to the more typical maculopapular and occasionally vesicular eruption noted by most people. Those with a history of exposure to the organisms have noted urticarial lesions at the onset of re-exposure. Intense itching causes many people to have difficulty sleeping.

Swimmer's itch is another example of a reaction to a parasite. Unlike sea lice, which occurs in salt water, swimmer's itch is a fresh water concern. The reaction is caused by a schistosome. The life cycle stage of the offending schistosome that affects humans is the cercariae, which leave a host snail to seek a warm-blooded host. If a host is found they attach to skin and penetrate with the aid of histolytic enzymes. In man, the cycle dead-ends: the cercaria penetrate and die beneath the epidermis causing an immediate hypersensitivity response. This response is variable and dependent on the degree of hypersensitivity induced by previous exposures.

After exposure, a person is first aware of a prickling sensation when cercaria penetrate the skin. The tingling lasts up to one hour and is accompanied by a macular eruption. Diffuse erythema or urticaria may occur during this stage. After an interval of ten to fifteen hours, a maculopapular eruption occurs accompanied by intensive itching and occasionally by purpuric lesions. This response resolves in about one week. Vesicle formation is not usual after the second and third day. Pustules may form if secondary infection occurs. The lesions are commonly confused with those of a contact dermatitis, poison ivy and insect bites from chiggers or mosquitoes.

Yet another cause of reactions, accompanied by burning is fire coral. This reaction is caused by Red Sea Coral (“stinging” or “fire coral”), a coelenterate of the Milleporina order and of the Hydrozoan class. It derives its name because it releases nematocysts, toxic organelles responsible for cutaneous lesions, immediately after contact with skin. Fire corals are not true corals. They have a bright yellow-green and brown skeletal covering and are widely distributed in tropical and subtropical waters. Divers often mistake fire coral for seaweed, and accidental contact is very common. Their very small nematocysts contain tentacles that protrude from numerous surface pores. In addition, they have a sharp, calcified external skeleton that can scrape the skin.

Contact with this coral can produce three types of cutaneous reactions: an acute urticaria-like, hemorrhagic or ulcero-necrotic reaction associated or not to anaphylaxis, a leukocytoklastic-like vasculitis and, in many of these latter cases, a delayed response of type IV. Most probably our case can be included into this last group.

In the majority of cases, soon after contact with fire coral an erythematous reaction appears, which spontaneously heals in about two months. Sometimes there is a lesion polymorphism. Thereafter, an acute vesiculo-bullous dermatitis follows; then there is a subacute granulomatous dermatitis and, in the last phase, a chronic lichenoid dermatitis.

A final example of a parasite that causes a pruritc reaction, this one land based, is the chigger. Chiggers are the larvae of harvest mites and belong to the family Trombiculidae. Chiggers feed on low vegetation, but they need animals as a source of protein. Chiggers do not burrow into the skin; instead they attach themselves to the opening of a hair shaft and inject saliva into the skin. When on a person, chiggers go to areas where the skin is thin and moist: the ankles, wrists, thighs, groin or waist. The mite stays in this area until feeding is complete, typically one to four days.

In some people, the initial chigger bite can trigger an allergic response and a rash may appear on surrounding areas of skin. After attachment, chiggers cause intense itching and small reddish welts on the skin.

Remedies for these reactions include the folk remedies of garlic, athletes foot spray, lemon, hydrogen peroxide, witch hazel, rubbing alcohol, spray starch, Epsom salts, and meat tenderizer. Other attempts to obtain relief included fingernail polish, undiluted bleach, ammonia, gasoline and turpentine. These are especially notable because they were used on extremely sensitive areas of people's bodies. Historically accepted medical treatment of these dermatitis includes antihistamine, such as diphenhydramine, for the itching and the application of an over-the-counter 0.5% hydrocortisone cream to the rash areas. Persons suffering from external eruptions, with or without urticaria, or with recurrences of symptoms may benefit from the administration of epinepherine as well as oral or intramuscular steroids. 1.0% corticosteroid cream can also be given. Colloidal oatmeal preparation and applying calamine lotion may also be used to provide temporary relief.

One thing these reactions have in common, along with many other dermatologic reactions, is their urticaria-like response. Urticaria, also known as hives, is an itching wheal reaction. Urticaria generally last only a few hours. Most urticarial reactions are due to ingestion of certain drugs or foods (shellfish and fresh berries are common causes).

Against this background, the Inventor has discovered that a combination of a sarcosinate, nonyl phenyl ethoxylate, and a scrubbing agent are effective in providing relief for these outbreaks.

### OBJECTS OF THE INVENTION

It is an object of the present invention to provide a treatment that helps to alleviate the local signs and symptoms caused by biting and penetrating organism and parasites.

It is a further object of the present invention to provide a method of use of the present inventive treatment.

It is yet another object of the present invention to provide a treatment that includes at least one ethoxylate, a sarcosinate and a scrubbing agent.

It is a yet further object of the present invention to provide a treatment that is safe to use.

It is yet another object of the present invention to provide such treatment that is topical, can be purchased over the counter, and is economical.

### SUMMARY OF THE INVENTION

The above objects of the invention are provided for in a topical treatment for biting and penetrating organisms and parasites. According to the invention, a method is provided for applying a composition of substances to the affected area, working the composition into the affected area, and removing the composition from the affected area. The composition comprises at least one ethoxylate in combination with a sarcosinate and an inert scrubbing agent, such as polyethylene beads. Additionally, acetylated lanolin alcohol, a second ethoxylate, EDTA, a foam stabilizer, and water can also be added to the composition without effecting performance.

Other formulas that keep the polarity similar to that of the inventive formula will also work. To keep the polarity similar, it is necessary for the compound to have similar characteristics, such as Carbon chains, carbonyl groups, Nitrogen bound to Carbon, Aromatic ring(s), Oxylate groups, and appropriate functional groups at the ends of the individual molecules. The ideal substitute chemicals would have all of the characteristics mentioned above, but it is not necessary to have every one of those as listed. For example, if the functional groups at the ends of the individual molecules are exchanged for other functional groups that retain the ability to undergo an emulsion polymerization, then the effectiveness of the compound is also retained. Another example is to change the ethoxylate to a methoxylate or propoxylate. These formations would still retain a similar polarity but would be different compounds with different characteristics. Yet another example would be to exchange triply bound Nitrogen with a doubly bound or perhaps Nitrogen with 4 Carbons bound to it.

### DETAILED DESCRIPTION OF THE INVENTION

Chemical analysis and research has revealed that the inventive composition including at least an ethoxylate, a sarcosinate, and a scrubbing agent is effective in the treatment of biting or penetrating organisms and parasites. The Inventor has found that a nonyl phenol ethoxylate and sodium lauroyl sarcosinate work best in conjunction with polyethylene granules as the scrubbing agent.

The Inventor has also found, however, that other formulas that keep the polarity similar to that of the inventive formula will also work. To keep the polarity similar, it is necessary for the compound to have similar characteristics, such as Carbon chains, carbonyl groups, Nitrogen bound to Carbon, Aromatic ring(s), Oxylate groups, and appropriate functional groups at the ends of the individual molecules so that an emulsion polymerization can take place. The ideal substitute chemicals would have all of the characteristics mentioned above, but it is not necessary to have every one of those as listed. For example, if the functional groups at the ends of the individual molecules are exchanged for other functional groups that retain the ability to undergo an emulsion polymerization, then the effectiveness of the compound is also retained. Another example is to change the ethoxylate to a methoxylate or propoxylate. These formations would still retain a similar polarity but would be different compounds with different characteristics. Yet another example would be to exchange triply bound Nitrogen with a doubly bound or perhaps Nitrogen with four carbons bound to it.

The scrubbing agent, which preferably is polyethylene granule beads, should be large enough to be effective but not so large as to cause abrasions. The inventor suggests beads in the range of 5 to 50 microns with an average size being approximately 25 microns or 50 mesh.

To make the inventive composition, an exact ratio of ethoxylate to sarcosinate (in the following discussion sodium lauroyl sarcosinate is used but any sarcosinate meeting the requirements can be used) is not critical. The only requirement is that the ethoxylate is completely reacted with the SLS, creating a polymer. This will vary with the ethoxylate used, but the Inventor has determined that a ratio of ethoxylate-to-SLS of 1.5:2 is preferred. The amount by weight of polyethylene beads can vary according to the grittiness desired. The Inventor has found that a formula of ethoxylate:SLS:polyethylene of 40:20:40 is preferred but that formulas of other concentrations are useful. Thus, for production purposes, formulas having SLS ranging from 10 to 20% by weight, ethoxylate ranging from 20 to 40% by weight, and polyethylene beads from 20 to 50% by weight are reasonable. But again, the formula is not restricted to these ranges, which ranges are presented for example purposes only.

Also, a cutting agent that does not chemically react with the composition may be added. The cutting agent makes the overall composition flow more easily, thereby enabling more packaging options, such as tubes. The cutting agent must be added only in sufficient amount that it promotes flow but does not effect the action of the composition.

In use, an sufficient amount of the composition is used to cover the affected area, the composition is applied to an affected area and worked over the area by a scrubbing motion. After sufficient time has elapsed to ensure that the affected area has been adequately exposed to the composition such that they area feels clean, approximately ten to thirty seconds for the typical person, the area is rinsed cleaned.

1. A treatment for biting and penetrating organisms and parasites comprising a sarcosinate, a ethoxylate, and a scrubbing agent in combination.

2. The treatment for biting and penetrating organisms and parasites of claim 1 wherein the sarcosinate is sodium lauroyl sarcosinate.

3. The treatment for biting and penetrating organisms and parasites of claim 1 wherein the ethoxylate is a nonyl phenyl ethoxylate.

4. The treatment for biting and penetrating organisms and parasites of claim 1 wherein the scrubbing agent is polyethylene granules.

5. The polyethylene granules of claim 4 in which the granules are in the range of 4 to 50 microns.

6. The treatment for biting and penetrating organisms and parasites of claim 1 further including a second nonyl phenyl ethoxylate.

7. The treatment for biting and penetrating organisms and parasites of claim 1 further including acetylated lanolin alcohol.

8. The treatment for Biting and penetrating organisms and parasites of claim 1 further including water.

9. The treatment for biting and penetrating organisms and parasites of claim 1 further including ethylenediaminetetraacetic acid.

10. The treatment for biting and penetrating organisms and parasites of claim 1 further including a foam stabilizing agent.

11. The treatment for biting and penetrating organisms and parasites of claim 1 further including a cutting agent.

12. The cutting agent of claim 11 being selected from the group of aqueous based solutions and oil based solutions.

13. The treatment for biting and penetrating organisms and parasites of claim 1 wherein the ethoxylate is exchanged for a methoxylate.

14. The treatment for biting and penetrating organisms and parasites of claim 1 wherein the ethoxylate is exchanged for a propoxylate.

15. A treatment for biting and penetrating organisms and parasites comprising: a first ethoxylate, acetylated lanolin alcohol, sodium lauroyl sarcosinate, EDTA, a foam stabilizer, water, and inert polyethylene granules.

16. The treatment for biting and penetrating organisms and parasites of claim 15 wherein the first ethoxylate is exchanged for a methoxylate.

17. The treatment for Biting and penetrating organisms and parasites of claim 15 wherein the first ethoxylate is exchanged for a propoxylate.

18. A treatment for biting and penetrating organisms and parasites comprising an ethoxylate, sodium lauroyl sarcosinate, and EDTA.

19. The treatment for biting and penetrating organisms and parasites of claim 18 wherein the ethoxylate is exchanged for a methoxylate.

20. The treatment for Biting and penetrating organisms and parasites of claim 18 wherein the ethoxylate is exchanged for a propoxylate.

21. A method for treating Biting and penetrating organisms and parasites comprising the steps of:
preparing a composition comprising an ethoxylate, a sarcosinate, and a scrubbing agent;
applying the composition to an affected area;
permitting the composition to remain on the affected area a sufficient amount of time to enable the composition of matter to cause an effect; and,
removing the composition from the affected area.

22. The method of claim 21 wherein preparing the composition further includes adding second ethoxylate.

23. The method of claim 21 wherein preparing the composition further includes adding acetylated lanolin alcohol.

24. The method of claim 21 wherein preparing the composition further includes adding acetylated polyethylene granules as the scrubbing agent.

25. The method of claim 21 wherein preparing the composition further includes adding water.

26. The method of claim 21 wherein preparing the composition further includes EDTA.

27. The method of claim 21 wherein preparing the composition further includes a foam stabilizer.

28. The method of claim 21 further including the step of adding a thinning agent to the composition.

29. The method of claim 21 wherein the ethoxylate is exchanged for a methoxylate.

30. The method of claim 21 wherein the ethoxylate is exchanged for a propoxylate.
